(19) United States
(12) Patent Application Publication
(10) Pub. No.: US 2026/0131886 A1
(43) Pub. Date: May 14, 2026

(54) ACTUATION MECHANISM FOR A HIGH LIFT SYSTEM, ASSOCIATED HIGH LIFT SYSTEM, AIRCRAFT AND METHOD OF ACTUATING A HIGH LIFT SYSTEM

(71) Applicant: Airbus Operations GmbH, HAMBURG (DE)

(72) Inventors: Bernhard SCHLIPF, HAMBURG (DE); Markus GIBBERT, HAMBURG (DE)

(21) Appl. No.: 19/384,119

(22) Filed: Nov. 10, 2025

(30) Foreign Application Priority Data
Nov. 12, 2024 (DE) 10 2024 132 959.9

(51) Int. Cl. B64C 9/24; B64C 3/50; B64C 13/30

(52) U.S. Cl. CPC B64C 9/24; B64C 3/50; B64C 13/30

(57) ABSTRACT

An actuation device for moving a high lift of an aircraft surface relative to a wing body. The actuation device has a guiding linkage, configured for guiding a displacement of the high lift surface relative to the wing body, a rocker, configured to be moveable in rotation relative to the wing body, a rotational actuator, comprising a housing and an actuation element, the housing being fastened to the rocker and the actuation element being moveable in rotation relative to the housing, and an actuation linkage configured for displacing the rocker and the high lift surface relative to the wing body upon rotation of the actuation element relatively to the housing.

### CROSS-REFERENCES TO RELATED APPLICATIONS

This application claims the benefit of German Patent Application Number 10 2024 132 959.9 filed on Nov. 12, 2024, the entire disclosure of which is incorporated herein by way of reference.

### FIELD OF THE INVENTION

The present disclosure relates to an actuation mechanism for a high lift system. The disclosure also relates to a high lift system comprising such an actuation mechanism. The disclosure further relates to an aircraft comprising such a high lift system and to a method of actuating such a high lift system.

### BACKGROUND OF THE INVENTION

In the domain of actuation mechanisms for high lift systems, and for example for Krüger flaps, one knows using rotational actuators, such as geared rotary actuators (often abbreviated GRA), to deploy and retract the high lift surfaces. The rotational actuator of such known mechanism is generally fastened to a wing body and moves linkages, connected to the high lift surface, in order to move the high lift surface relative to the wing body.

In order to limit the spatial footprint of such actuation mechanisms in the wing body, one knows for example using linkage elements having a shape adapted to receive the rotational actuator when the high lift surface is retracted. Such linkages are often referred to as “swan neck” or “goose neck”, because of their specific shape.

Such mechanisms are however not entirely satisfying. Indeed, such mechanism require the rotational actuator to be arranged near the leading edge of the wing body. In high performance wings, such as laminar wings, the thickness of the wing near the leading edge is limited such as integration of known mechanisms is especially challenging.

### SUMMARY OF THE INVENTION

An object of the present invention is therefore to provide an actuation mechanism for a high lift system for which the integration in a high-performance wing is improved.

To this end, the invention relates to an actuation mechanism for a high lift system, configured for moving a high lift surface relative to a wing body, the actuation mechanism comprising:
a guiding linkage, configured to be connected to the high lift surface and for guiding a displacement of the high lift surface relative to the wing body,
a rocker, configured to be connected to the wing body and to be moveable in rotation relative to the wing body;
a rotational actuator, comprising a housing and an actuation element, the housing being fastened to the rocker and the actuation element being moveable in rotation relative to the housing; and
an actuation linkage, connected to the actuation element and configured to be connected to the high lift surface and to the wing body, the actuation linkage being configured for displacing the rocker and the high lift surface relative to the wing body upon rotation of the actuation element relatively to the housing.

The use of an actuation mechanism comprising rotational actuator mounted on a rocker as presented above is especially relevant since this allows the actuator to be distanced to the leading edge of the wing body while ensuring a proper actuation of the high lift surface.

According to other advantageous aspects of the invention, the actuation mechanism comprises one or more of the following features taken alone or according to all technically possible combinations:
the guiding linkage is configured to be connected to the wing body and for guiding the displacement of the high lift surface in rotation relative to the wing body;
the guiding linkage is connected to the rocker and configured for guiding the displacement of the high lift surface in rotation relative to the rocker;
the guiding linkage is configured to be fastened to the high lift surface, the guiding linkage extending substantially along a L shape;
the actuation linkage comprises a proximal link element, an actuation link element and a distal link element,
the actuation link element being fastened to the actuation element,
the proximal link element being connected to the actuation link element and being moveable in rotation relative to the actuation link element, the proximal link element being further configured for being connected to the wing body and for being moveable in rotation relative to the wing body,
the distal link element being connected to the actuation link element and being moveable in rotation relative to the actuation link element, the distal link element being further configured for being connected to the high lift surface and for being moveable in rotation relative to the high lift surface;
   the actuation link element comprises two non-aligned actuation arms;
   an angle between the two non-aligned actuation arms is comprised between 5° and 30°;
   the proximal link element is shorter than the distal link element; and
   the rocker comprises a main body and a connection section, the housing of the rotational actuator being fastened to the main body and the connection section being configured to be connected to the wing body for the rocker to be moveable in rotation relative to the wing body.

The invention further relates to a high lift system comprising a wing body, a high lift surface and an actuation mechanism as presented above, the guiding linkage of the actuation mechanism being connected to the high lift surface, the rocker of the actuation mechanism being connected to the wing body and the actuation linkage of the actuation mechanism being connected to the high lift surface and to the wing body.

According to an advantageous aspect of the invention, the high lift surface is forming a Krüger flap.

The invention further relates to an aircraft comprising a high lift system as presented above.

The invention further relates to a method of actuating a high lift system as presented above, wherein the method comprises:
actuation of the rotational actuator to move the actuation element relatively to the housing of the rotational actuator;
displacement of the high lift surface relative to the wing body by the actuation linkage;
guiding of the displacement of the high lift surface relative to the wing body by the guiding linkage; and
rotation of the rocker relative to the wing body.

According to other advantageous aspects of the invention, the method of actuating a high lift system comprises one or more of the following features taken alone or according to all technically possible combinations:
the high lift system is actuated between a retracted position and a deployed position, the actuation between the retracted and the deployed position comprising:
a first phase, in which the rocker rotates in a first direction relative to the wing body, and
a second phase, in which the rocker rotates in a second direction relative to the wing body, the second direction being opposed to the first direction; and
the rocker is arranged in an inner volume defined by the wing body when the high lift system is in its retracted position and in its deployed position.

### BRIEF DESCRIPTION OF THE DRAWINGS

The invention will be better understood when reading the following description, which is given solely by way of example and with reference to the appended drawings, in which:

FIG. 1 is a schematic view of an aircraft comprising a high lift system with an actuation mechanism according to the invention;

FIG. 2 is a schematic view of the high lift system of FIG. 1, wherein the high lift system is in a retracted position;

FIG. 3 is a schematic view similar to the view of FIG. 2, wherein the high lift system is in a first intermediate position, between its retracted and deployed positions;

FIG. 4 is a schematic view similar to the view of FIGS. 2 and 3, wherein the high lift system is in a second intermediate position, between its retracted and deployed positions;

FIG. 5 is a schematic view similar to the view of FIGS. 2 to 4, wherein the high lift system is in a deployed position; and

FIG. 6 is a schematic view similar to the view of FIG. 3, of another example of high lift system.

### DETAILED DESCRIPTION OF THE PREFERRED EMBODIMENTS

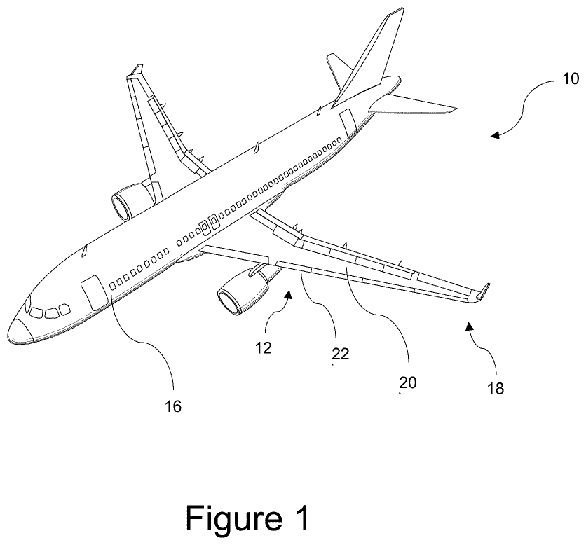

As illustrated in FIG. 1, an aircraft 10 comprises a high lift system 12.

The aircraft 10 is for example an airplane and for example an airliner. As visible from FIG. 1, the aircraft 10 comprises a fuselage 16 and wings 18.

For example, and as illustrated on FIG. 1, each wing 18 of the aircraft 10 comprises at least one high lift system 12.

The high lift system 12 comprises a wing body 20, a high lift surface 22 and an actuation mechanism 24 for the high lift system 12. In an example, the high lift system 12 comprises a plurality of actuation mechanisms 24, as this will be presented hereinafter.

The wing body 20 is for example a portion of the wing 18 being fixed relative to the fuselage 16, such as for example a wingbox of the wing 18.

The high lift surface 22 is moveable relative to the wing body 20 and is in particular moveable relative to the wing body 20 through the actuation mechanism 24.

The high lift surface 22 is in particular moveable between a retracted position and a deployed position, corresponding to retracted and deployed positions of the high lift system 12.

In the retracted position, the high lift surface 22 is retracted, or in other word stowed, relative to the wing body 20.

The high lift surface 22 is for example configured to adopt its retracted position when the aircraft 10 is in a cruise configuration.

In the deployed position, the high lift surface 22 is deployed relative to the wing body 20, for example such that the high lift surface 22 is further away from the wing body 20 when it is in its deployed position than when it is in its retracted position. The high lift surface is for example configured to increase a camber and/or a surface of the wing 18 when it is in its deployed position.

The high lift surface 22 is for example configured to adopt its deployed position when the aircraft is in a take-off or landing configuration.

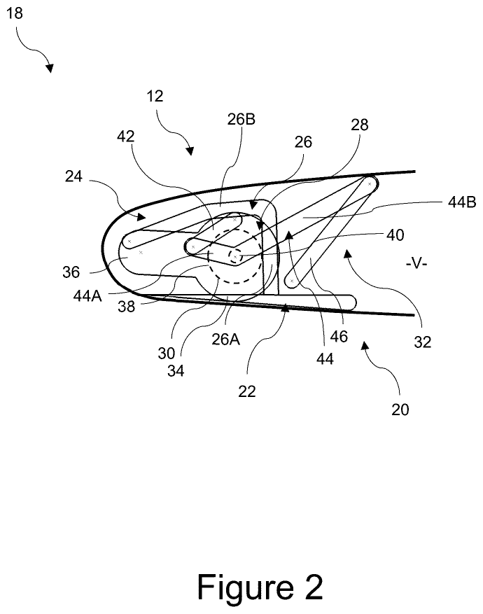

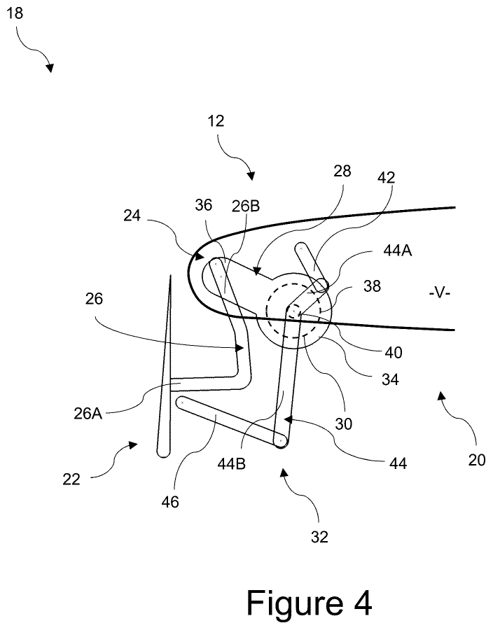

As visible from FIG. 2 to 5 and 6, the high lift surface 22 is for example forming a Krüger flap. In other word, and in such an example, the high lift surface 22 is for example forming the flap of such a Krüger flap and the actuation mechanism 24 is forming a Krüger flap actuation system

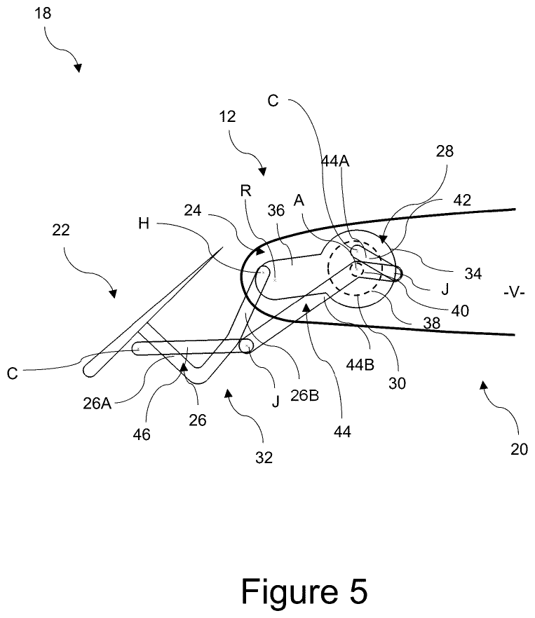

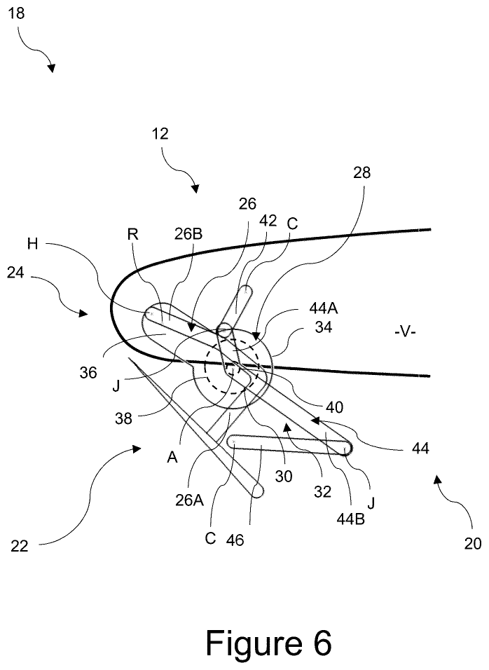

One understands that a Krüger flap is for example a leading edge high lift system 12 for which the high lift surface 22 is rotatable around a hingeline H (presented in more details later and only referenced in FIGS. 5 and 6 for readability purposes), preferably arranged near a leading edge of the wing body 20, such that a lower face of high lift surface 22 when the high lift surface is in its retracted position corresponds to a upper face once the high lift surface 22 is in its deployed position.

The actuation mechanism 24 is configured for moving the high lift surface 22 relative to the wing body 20, for example between the deployed position of the high lift surface 22 and the retracted position of the high lift surface 22.

The actuation mechanism 24 comprises a guiding linkage 26, a rocker 28, a rotational actuator 30 and an actuation linkage 32.

The guiding linkage 26, is configured to be connected to the high lift surface 22 and for guiding a displacement of the high lift surface 22 relative to the wing body 20. The guiding linkage 26 is in particular connected to the high lift surface 22 such that it guides the displacement of the high lift surface 22 between its deployed and retracted positions relative to the wing body 20.

As visible on FIGS. 2 to 5 and 6, the guiding linkage 26 is for example fastened to the high lift surface 22.

The guiding linkage 26 is further for example configured to be connected to the wing body 20.

In the example of FIGS. 2 to 5, the guiding linkage 26 is directly connected to the wing body 20. For example, the guiding linkage 26 is rotatably mounted on the wing body 20 such that the high lift surface 22, for example fastened on the guiding linkage 26, is rotatable relative to the wing body 20. The guiding linkage 26 is for example configured for guiding the high lift surface 22 in rotation relative to the wing body 20. For example, the guiding linkage 26 is configured for guiding the high lift surface 22 in rotation around a hingeline H, the hingeline H being for example fixed relative to the wing body 20.

As understood from FIGS. 2 to 5, the hingeline H extends for example along a spanwise direction of the wing body 20, for example at, or near, a leading edge (non-referenced) of the wing body 20.

As this will be presented in more details later on, and as presented in the example of FIG. 6, the guiding linkage 26 is indirectly connected to the wing body 20. In particular, in this example, the guiding linkage 26 is connected to the wing body through the rocker 28.

In the example of FIGS. 2 to 6, the guiding linkage 26 extends substantially (i.e., +/−10%) along a L shape. In particular, the guiding linkage 26 comprises a first portion 26A and a second portion 26B, the first 26A and section 26B portions being for example substantially perpendicular one relative to another.

In the example of FIG. 2 to 5, the first portion 26A is fastened to the high lift surface 22 and the second portion 26B is moveable in rotation relative to the wing body 20 around the hinge line H.

As visible from FIGS. 2 to 6, although extending substantially along a L shape, at least one of the first 26A and second 26B portion of the guiding linkage 26 might be curved at least in one region (not referenced), such that said portion is not linear.

The rocker 28 is configured to be connected on the wing body 20 and to be moveable in rotation relative to the wing body 20.

As visible from FIGS. 2 to 5 and 6, the rocker is for example connected to the wing body 20 and moveable in rotation around a rocker axis R (only referenced in FIGS. 5 and 6 for readability purposes), relative to the wing body 20. The rocker axis R is for example substantially parallel to the hinge line H.

As presented in FIGS. 2 to 5 and 6, the rocker 28 comprises for example a main body 34 and a connection section 36. In such an example, the connection section 36 connects for example the main body 34 to the wing body 20 such that the main body 34 of the rocker 28 is moveable in rotation relative to the wing body 20, for example around the rocker axis R defined for example by the connection section 36.

As this will be presented in more details later, the rotational actuator 30 is for example connected to the rocker 28 and moveable with the rocker 28 around the rocker axis R.

The rotational actuator 30 comprises for example a housing 38 and an actuation element 40.

The rotational actuator 30 is for example connected to a control module (non-illustrated), the control module being for example configured to control the rotational actuator 30. The control module is for example configured to control deployment/retraction of the high lift surface 22 by controlling the rotational actuator 30, or in other words, relative displacement between the housing 38 and the actuation element 40.

The actuation element 40 is for example moveable in rotation relative to the housing 38, for example around an actuation axis A (only referenced in FIGS. 5 and 6 for readability purposes). The actuation axis is for example substantially parallel to the hinge line H and/or to the rocker axis R.

As visible from FIGS. 2 to 5 and 6, the housing 38 is for example fastened to the rocker 28, and for example to the main body 34 of the rocker 28. In a non-illustrated example the housing 38 and the rocker 28 are integral.

The actuation element 40 is then for example moveable in rotation around the actuation axis A relative to the housing 38 such that it moveable in rotation around the rotation axis A relative to the rocker 28.

As visible from FIGS. 2 to 5 and 6, the actuation linkage 32 is connected to the actuation element 40, in particular such that the rotational actuator 30 is configured for moving the actuation linkage 32 relative to the rocker 28.

For example, the actuation linkage 32 is fastened to the actuation element 40.

As visible from FIGS. 2 to 5 and 6, the actuation linkage 32 is further configured to be connected to the high lift surface 22 and to the wing body 20. In particular, and for example, the actuation linkage is connected to the high lift surface 22 an to the wing body 20 to be locally moveable in rotation around the high lift surface 22 and to the wing body 20

As understood from FIGS. 2 to 5, the actuation linkage 32 is configured for displacing the rocker 28 and the high lift surface relative to the wing body 20 upon rotation of the actuation element 40 relatively to the housing 38.

The actuation linkage 32 comprises for example a proximal link element 42, an actuation link element 44 and a distal link element 46.

The actuation link element 44 is for example fastened to the actuation element 40. In a non-illustrated example, the actuation link element 44 and the actuation element 40 are integral.

The actuation link element 44 is for example connected to the proximal link element 42 and to the distal link element 46. For example, the proximal link element 42 is moveable in rotation relative to the actuation link element 44 and the distal link element 46 is moveable in rotation relative to the actuation element 44.

For example, the proximal link element 42, the actuation link element 44 and the distal link element 46 are articulated so that they can be moved one relative to another around junction axes J (only referenced in FIGS. 5 and 6 for readability purposes) being substantially parallel to the actuation axis A.

In the example of FIGS. 2 to 5 and 6, the actuation link element 44 comprises two non-aligned actuation arms 44A, 44B. The non-aligned actuation arms 44A, 44B are fixed one relative to another and are for example integral.

For example, a first 44A of the actuation arms 44A, 44B is connected, for example articulated, to the proximal link element 42 and a second 44B of the actuation arms 44A, 44B is connected, for example articulated, to the distal link element 46.

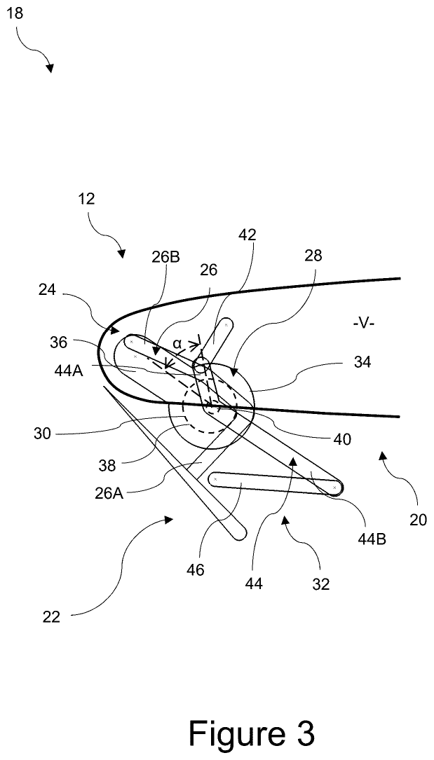

An angle α (only referenced on FIG. 3 for readability purposes) between the two non-aligned actuation arms 44A, 44B is for example comprised between 5° and 30°.

A length L1 of the first actuation arm is 44A is for example shorter than a length L2 of the second actuation arm 44B (L1 and L2 being non-referenced in the drawings for readability purposes). A ratio of the length L1 of the first actuation arm is 44A over the length L2 of the second actuation arm 44B is for example comprised between 20 and 50%.

As presented above, the proximal link element 42 is connected to the actuation link element 44 and is for example moveable in rotation relative to the actuation link element 44. Furthermore, as visible from FIGS. 2 to 5 and 6, the proximal link element 42 is further for example connected to the wing body 20 and is moveable in rotation relative to the wing body 20.

As presented above, the distal link element 46 is connected to the actuation link element 44 and is for example moveable in rotation relative to the actuation link element 44. Furthermore, as visible from FIGS. 2 to 5 and 6, the distal link element 46 is further for example connected to the high lift surface 22 and is moveable in rotation relative to high lift surface 22.

As visible from FIGS. 2 to 5 and 6, the distal link element 46 and the high lift surface 22, as well as the proximal link element 42 and the wing body 20, are articulated around connection axes C (only referenced in FIGS. 5 and 6 for readability purposes), the connection axes being for example substantially parallel to the actuation axis A.

The proximal link element 42 is for example shorter than the distal link element 46.

A ratio of a length LP of the proximal link element 42 over the length L1 of the first actuation arm is for example comprised between 90% and 120% (LP being non-referenced in the drawings for readability purposes).

A ratio of a length LD of the distal link element 46 over the length L2 of the second actuation arm is for example comprised between 60 % and 110% (LD being non-referenced in the drawings for readability purposes.

A ratio of the length LP of the proximal link element 42 over the length LD of the distal link element 46 is for example comprised between 20% and 60%.

The example presented in FIG. 6 will now be presented in more details. This example differs from the example presented in FIGS. 2 to 5 only by the following elements.

As previously mentioned, and in this example the guiding linkage 26 is not directly connected to the wing body 20 but is instead connected to the rocker 28. In particular, the guiding linkage 26 is then configured for guiding the displacement of the high lift surface 22 in rotation relative to the rocker 28.

The hinge line H is then, in such an example, configured for moving along with the rocker 28.

A method of actuating a high lift system 12 comprising an actuation mechanism 24 as above described will now be presented.

The method comprises the actuation of the rotational actuator 30 to move the actuation element 40 relatively to the housing 38 of the rotational actuator 30.

The method further comprises the displacement of the high lift surface 22 relative to the wing body 20 by the actuation linkage 32. In particular, the displacement of the high lift surface 22 relative to the wing body 20 by the actuation linkage 32 results from the displacement actuation linkage 32 resulting for the actuation of the rotational actuator and from the interaction of such displaced actuation linkage with the high lift surface 22 and with the wing body 20.

The method further comprises the guiding of the high lift surface 22 relative to the wing body by the guiding linkage 26. The high lift is for example guided by the guiding linkage 26 in its displacement induced by the actuation linkage 32.

The method further comprises the rotation of the rocker 28 relative to the wing body 20. The rotation of the rocker 28 relative to the wing body 20 results for example of the actuation of the rotational actuator 30 and of the interaction between the guiding linkage 26 and the wing body 20.

One then understands that the above mentioned actuation, displacement, guiding and rotation are for example happening simultaneously, and that this results for example in the actuation of the high lift system 12 between its retracted and deployed positions.

Furthermore, and for example, the actuation of the high lift system 12 between its retracted and deployed positions comprises a first phase, in which the rocker 28 rotates in a first direction (non-represented) relative to the wing body 20 and a second phase, in which the rocker 28 rotates in a second direction (non-represented) relative to the wing body 20, the second direction being opposed to the first direction.

Furthermore, and as presented in FIGS. 2 and 5, the rocker is arranged in an inner V volume defined by the wing body 20 when the high lift system 12 is in its retracted position (illustrated in FIG. 2) and in its deployed position (illustrated in FIG. 5). In other words, the rocker 28 may rotate out of the inner volume V during the deployment/retraction of the high lift system 12, but in this example, remains in the inner volume once the high lift system reaches its retracted or deployed position.

As presented above, the use of an actuation mechanism 24 the use of a rocker 28 as presented above to support the rotational actuator 30 is especially relevant to improve the positioning of the rotational actuator 30 in the wing body 20 while ensuring a proper actuation of the high lift surface 22.

The connection of the guiding linkage 26 to the wing body 20 or to the rocker 28 allows for a further improved positioning and/or load transmission for the actuation mechanism.

The use of L shaped guiding linkage 26 and/or of an actuation linkage 32 comprising a proximal 42, an actuation 44 and a distal 46 link elements is especially advantageous for its limited tridimensional footprint.

The previously presented geometry of the actuation linkage 32 is also especially relevant to ensure a proper load distribution in the high lift system 12 and in turns a proper actuation of the high lift system 12.

The rocker 28 comprising a main body 34 and a connection section 36 as presented above is also especially advantageous for improving the integration of the actuation mechanism 24 in the wing body 20.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

10 aircraft
12 high lift system
16 fuselage
18 wing
20 wing body
22 high lift surface
24 actuation mechanism
26 guiding linkage
26A first portion of the guiding linkage
26B second portion of the guiding linkage
28 rocker
30 rotational actuator
32 actuation linkage
34 main body
36 connection section
38 housing
40 actuation element
42 proximal link element
44 actuation link element
44A first actuation arm
44B second actuation arm
46 distal link element
C connection axis
H hinge line
R rocker axis
A actuation axis
J junction axis
α angle between first and second actuation arms
L1 length of the first actuation arm
L2 length of the second actuation arm
LP length of the proximal link element
LD length of the distal link element
V inner volume

1. An actuation mechanism for a high lift system configured for moving a high lift surface relative to a wing body, the actuation mechanism comprising:
a guiding linkage configured to be connected to the high lift surface and for guiding a displacement of the high lift surface relative to the wing body;
a rocker configured to be connected to the wing body and to move in rotation relative to the wing body;
a rotational actuator comprising a housing and an actuation element, the housing fastened to the rocker and the actuation element configured to move in rotation relative to the housing; and
an actuation linkage connected to the actuation element and configured to be connected to the high lift surface and to the wing body, the actuation linkage configured for displacing the rocker and the high lift surface relative to the wing body upon rotation of the actuation element relatively to the housing.

2. The actuation mechanism according to claim 1, wherein the guiding linkage is configured to be connected to the wing body and for guiding the displacement of the high lift surface in rotation relative to the wing body.

3. The actuation mechanism according to claim 1, wherein the guiding linkage is connected to the rocker and configured for guiding the displacement of the high lift surface in rotation relative to the rocker.

4. The actuation mechanism according to claim 1, wherein the guiding linkage is configured to be fastened to the high lift surface, and
wherein the guiding linkage extends substantially along a L shape.

5. The actuation mechanism according to claim 1, wherein the actuation linkage comprises a proximal link element, an actuation link element, and a distal link element,
the actuation link element fastened to the actuation element,
the proximal link element connected to the actuation link element and configured to move in rotation relative to the actuation link element, the proximal link element further configured to connect to the wing body and to move in rotation relative to the wing body, and,
the distal link element connected to the actuation link element and configured to move in rotation relative to the actuation link element, the distal link element further configured to connect to the high lift surface and to move in rotation relative to the high lift surface.

6. The actuation mechanism according to claim 5, wherein the actuation link element comprises two non-aligned actuation arms.

7. The actuation mechanism according to claim 6, wherein an angle between the two non-aligned actuation arms is between 5° and 30°.

8. The actuation mechanism according to claim 5, wherein the proximal link element is shorter than the distal link element.

9. The actuation mechanism according to claim 1, wherein the rocker comprises a main body and a connection section,
wherein the housing of the rotational actuator is fastened to the main body and the connection section is configured to connect to the wing body for the rocker to move in rotation relative to the wing body.

10. A high lift system comprising:
a wing body;
a high lift surface; and
the actuation mechanism according to claim 1, the guiding linkage of the actuation mechanism connected to the high lift surface, the rocker of the actuation mechanism connected to the wing body, and the actuation linkage of the actuation mechanism connected to the high lift surface and to the wing body.

11. The high lift system according to claim 10, wherein the high lift surface forms a Krüger flap.

12. An aircraft comprising:
the high lift system according to claim 10.

13. A method of actuating the high lift system according to claim 10, wherein the method comprises:
actuating the rotational actuator to move the actuation element relative to the housing of the rotational actuator;
displacing the high lift surface relative to the wing body by the actuation linkage;
guiding the displacement of the high lift surface relative to the wing body by the guiding linkage; and
rotating the rocker relative to the wing body.

14. The method according to claim 13, wherein the actuating is between a retracted position and a deployed position, wherein the method further comprises:
a first phase, in which the rocker rotates in a first direction relative to the wing body, and
a second phase, in which the rocker rotates in a second direction relative to the wing body, the second direction being opposed to the first direction.

15. The method according to claim 14, wherein the rocker is arranged in an inner volume defined by the wing body when the high lift system is in the retracted position and in the deployed position.
